(19) United States
(12) Patent Application Publication
(10) Pub. No.: US 2019/0130803 A1
(43) Pub. Date: May 2, 2019

(54) GRAYSCALE COMPENSATION AMOUNT DETERMINING METHOD AND DEVICE, DRIVING METHOD, CIRCUIT AND DISPLAY DEVICE

(71) Applicants: Beijing BOE Display Technology Co., Ltd., Beijing (CN); BOE TECHNOLOGY GROUP CO., LTD., Beijing (CN)

(72) Inventors: Bin ZHANG, Beijing (CN); Weitao CHEN, Beijing (CN)

(21) Appl. No.: 16/050,772

(22) Filed: Jul. 31, 2018

(30) Foreign Application Priority Data
Nov. 1, 2017 (CN) 201711057711.2

(51) Int. Cl. G09G 3/00; H04N 17/00; G09G 5/02

(52) U.S. Cl. CPC G09G 3/006; H04N 17/004; G09G 2310/0264; G09G 2320/0242; G09G 5/02

(57) ABSTRACT

A grayscale compensation amount determining method and device, a driving method for a display panel for display, a driving circuit for a display panel for display and a display device including the display panel for display and the driving circuit. The method includes a plurality of determining operations, each including: controlling display of a first test image on a display panel for test; obtaining a first display brightness of the display panel for test when the first test image is being displayed; controlling display of a second test image on the display panel for test; obtaining a second display brightness of the display panel for test when the second test image is being displayed; and determining a grayscale compensation amount based on a difference between the first theoretical brightness and the first display brightness, and a difference between the second theoretical brightness and the second display brightness.

### CROSS-REFERENCE TO RELATED APPLICATION

This application claims priority to Chinese Patent Application No. 201711057711.2 filed on Nov. 1, 2017, the contents of which are incorporated by reference in its entirety.

### TECHNICAL FIELD

The present disclosure relates to the field of display technology, and in particular, to a grayscale compensation amount determining method, a grayscale compensation amount determining device configured to perform the grayscale compensation amount determining method, a driving method for a display panel for display, a driving circuit configured to perform the driving method and a display device including the driving circuit.

### BACKGROUND

With the development of science, display technology has been increasingly applied to various fields of life and production. Moreover, requirements for the display effect of the display device are also increasing.

Therefore, how to further improve the display effect of the display device has become a technical problem to be solved in the art.

### SUMMARY

A grayscale compensation amount determining method including a plurality of determining operations is provided in one aspect of the present disclosure, each of the determining operations including:

controlling display of a first test image on a display panel for test, wherein the first test image has a first theoretical grayscale that corresponds to a first theoretical brightness;

obtaining a first display brightness of the display panel for test when the first test image is being displayed;

controlling display of a second test image on the display panel for test, wherein the second test image has a second theoretical grayscale that corresponds to a second theoretical brightness;

obtaining a second display brightness of the display panel for test when the second test image is being displayed; and

determining a grayscale compensation amount based on a difference between the first theoretical brightness and the first display brightness, and a difference between the second theoretical brightness and the second display brightness.

In one embodiment, the grayscale compensation amount determining method further includes:

generating a table for grayscale compensation amount, wherein the table includes a first theoretical grayscale, a second theoretical grayscale, and a corresponding grayscale compensation amount for each of the determining operations.

In one embodiment, the grayscale compensation amount determining method further includes: ensuring that at least one of a first theoretical grayscale of a first test image and a second theoretical grayscale of a second test image in one determining operation is different from that in another determining operation.

In one embodiment, the grayscale compensation amount determining method further includes ensuring that:

the first test image and the second test image are both images with solid color,

the first theoretical grayscale value of the first test image is different from the second theoretical grayscale of the second test image, and

the color of the first test image is the same as that of the second test image.

A grayscale compensation amount determining device is provided in another aspect of the disclosure, the device including:

a controller configured to control display of a group of test images on a display panel for test in a determining operation, wherein the group of test images include a first test image and a second test image, and wherein the first test image has a first theoretical grayscale that corresponds to a first theoretical brightness, and the second test image has a second theoretical grayscale that corresponds to a second theoretical brightness;

a brightness obtainer configured to obtain a first display brightness of the display panel for test when the first test image is being displayed and obtain a second display brightness of the display panel for test when the second test image is being displayed; and

a compensation calculator configured to determine a grayscale compensation amount based on a difference between the first theoretical brightness and the first display brightness, and a difference between the second theoretical brightness and the second display brightness.

In one embodiment, the controller is configured to control display of different groups of images on the display panel for test in different determining operations respectively, wherein at least one of a first theoretical grayscale of a first test image and a second theoretical grayscale of a second test image in one group of test images is different from that in another group of test images.

In one embodiment, the grayscale compensation amount determining device further includes the display panel for test.

In one embodiment, the display panel for test is an organic light emitting diode display panel.

In one embodiment, the brightness obtainer is a photosensitive sensor.

In one embodiment, the grayscale compensation amount determining device further includes a table generator configured to generate a table for grayscale compensation amount, wherein the table includes a first theoretical grayscale, a second theoretical grayscale, and a corresponding grayscale compensation amount for each of the determining operations.

A driving method for a display panel for display is provided in another aspect of the present disclosure, the method including:

obtaining a theoretical grayscale value of each pixel unit in an image currently displayed on the display panel for display which corresponds to the first theoretical grayscale value in the grayscale compensation amount determining method described above;

obtaining a theoretical grayscale value of each pixel unit in an image to be displayed which corresponds to the second theoretical grayscale value in the grayscale compensation amount determining method described above;

calculating an actual grayscale value of each pixel unit in the image to be displayed according to the following formula:

GA=G2+Gc

wherein GA is an actual grayscale value of the pixel unit to be calculated in the image to be displayed,

G2 is a theoretical grayscale value of the pixel unit to be calculated in the image to be displayed,

Gc is a grayscale compensation amount for the pixel unit to be calculated in the image to be displayed, and is calculated by the grayscale compensation amount determining method described above based on the theoretical grayscale value of the pixel unit to be calculated in the image to be displayed and a theoretical grayscale value of a pixel unit in the image currently displayed that corresponds to the pixel unit to be calculated in the image to be displayed; and

driving the display panel for display to display the image to be displayed according to the actual grayscale value of each pixel unit in the image to be displayed.

A driving circuit for a display panel for display is provided in another aspect of the present disclosure, the circuit including:

a processor comprising a theoretical grayscale obtaining unit and an actual grayscale determining unit, wherein:

the theoretical grayscale obtaining unit is configured to:
obtain a theoretical grayscale value of each pixel unit in an image currently displayed by the display panel for display which corresponds to the first theoretical grayscale value in the grayscale compensation amount determining device described above, and
obtain a theoretical grayscale value of each pixel unit in an image to be displayed which corresponds to the second theoretical grayscale value in the grayscale compensation amount determining device described above,

the actual grayscale determining unit is configured to calculate an actual grayscale value of each pixel unit in the image to be displayed according to the following formula:

GA=G2+Gc
wherein GA is an actual grayscale value of the pixel unit to be calculated in the image to be displayed,
G2 is a theoretical grayscale value of the pixel unit to be calculated in the image to be displayed,
Gc is a grayscale compensation amount for the pixel unit to be calculated in the image to be displayed, and is calculated by the grayscale compensation amount determining device described above based on the theoretical grayscale value of the pixel unit to be calculated in the image to be displayed and a theoretical grayscale value of a pixel unit in the image currently displayed that corresponds to the pixel unit to be calculated in the image to be displayed; and

a driving unit for driving the display panel for display to display the image to be displayed according to the actual grayscale value of each pixel unit in the image to be displayed.

In one embodiment, the driving circuit further includes a storing unit configured to store a table for grayscale compensation amount that includes the grayscale compensation amount.

A display device is provided in another aspect of the present disclosure, the device including a display panel for display and a driving circuit, wherein the driving circuit is the driving circuit described above in the present disclosure, and the display panel for display has a same structure as the display panel for test described above.

### BRIEF DESCRIPTION OF THE FIGURES

For better understanding of the disclosure, the drawings which constitute a part of the specification are provided so as to illustrate the disclosure in conjunction with the following specific embodiments, and are not intended to limit the scope of the disclosure. In the drawings,

FIG. 1 is a graph of response brightness when the grayscale of the OLED display device is switched;

FIG. 2 is a flow diagram of a grayscale compensation amount determining method according to an embodiment of the present disclosure;

FIG. 3 is a structure schematic diagram of a grayscale compensation amount determining device according to an embodiment of the present disclosure;

FIG. 4 is a schematic diagram of a lookup table for grayscale compensation amount according to an embodiment of the present disclosure;

FIG. 5 is a flow diagram of a driving method for a display panel according to an embodiment of the present disclosure; and

FIG. 6 is a structure schematic diagram of a driving circuit according to an embodiment of the present disclosure.

### DETAILED DESCRIPTION

The specific embodiments of the present disclosure will be described in detail below in conjunction with the accompanying drawings. It is to be noted that the embodiments are presented herein for purpose of illustration and description only, and are not intended to limit the scope of the present disclosure.

Due to process limitation, the overall performance of a display panel is not uniform. When a video is displayed on a display panel whose overall performance is not uniform, a phenomenon of low brightness and streaking is likely to occur when switching from a still image to a first frame of the video. As shown in FIG. 1, when an image with a grayscale of 0 is switched to a first frame of a video with a grayscale of 128 on a display panel, the first frame of the video displayed on the display may not reach a grayscale of 128 due to insufficient response speed. This also causes a significant streaking effect when displaying pictures with a high speed (i.e., displaying a video) on the display panel.

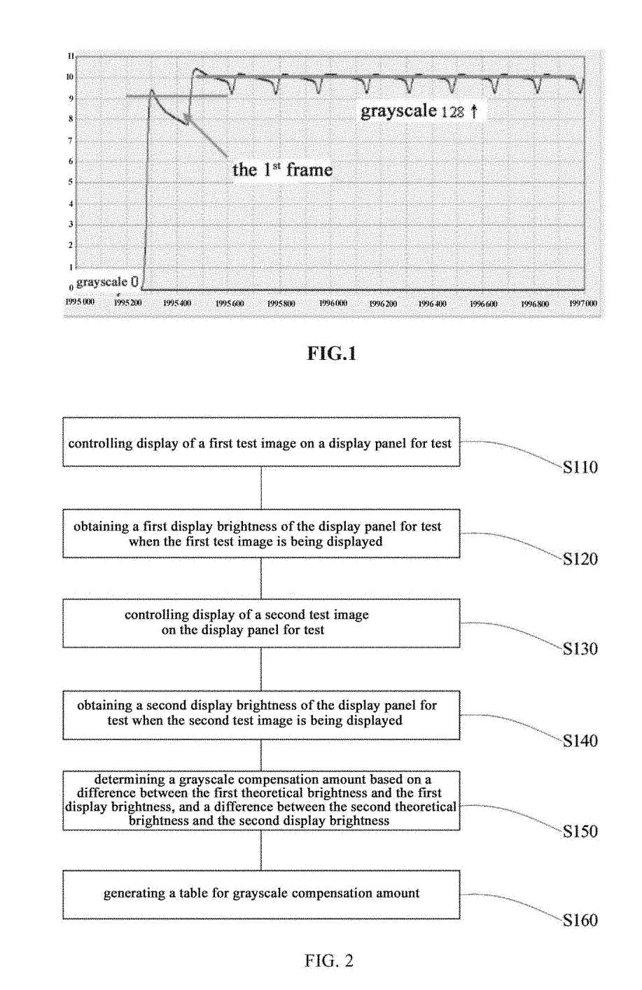

In view of this, a grayscale compensation amount determining method is provided in an aspect of the present disclosure. FIG. 2 illustrates the grayscale compensation amount determining method according to an embodiment of the present disclosure. As shown in FIG. 2, the grayscale compensation amount determining method includes a plurality of determining operations, and each of the determining operations includes steps S110-S150.

At step S110, display of a first test image on a display panel for test is controlled, wherein the first test image has a first theoretical grayscale g1 that corresponds to a first theoretical brightness b1.

At step S120, a first display brightness B1 of the display panel for test is obtained when the first test image is being displayed.

At step S130, display of a second test image on the display panel for test is controlled, wherein the second test image has a second theoretical grayscale g2 that corresponds to a second theoretical brightness b2.

At step S140, a second display brightness B2 of the display panel for test is obtained when the second test image is being displayed.

At step S150, a grayscale compensation amount is determined based on a difference between the first theoretical brightness b1 and the first display brightness B1, and a difference between the second theoretical brightness b2 and the second display brightness B2.

It is to be noted that, in the compensation amount determining method provided by the present disclosure, the first test image and the second test image are both images with solid color, the theoretical grayscale value of the first test image is different from that of the second test image, and the color of the first test image is the same as that of the second test image. For example, the first test image and the second test image may both be red, or may both be green, or blue.

It will be readily understood by those skilled in the art that any grayscale value corresponds to a theoretical brightness value (i.e., when a pixel unit emits light according to a grayscale value, a theoretical brightness can be obtained theoretically). For convenience of description, in the present application, the first theoretical grayscale value g1 corresponds to the first theoretical brightness value b1, and the second theoretical grayscale value g2 corresponds to the second theoretical brightness value b2.

When a grayscale switching occurs for a pixel unit in the display panel, there are at least two factors that may affect the display effect (i.e., the display luminance): one is the manufacturing process of the display panel, and the other is the response speed of the display panel when switching from a static image to a dynamic one.

In the present disclosure, by calculating the difference between the first theoretical brightness b1 and the first display brightness B1, the influence of the manufacturing process of the display panel on the display of the same still image may be determined. Moreover, by determining the grayscale compensation amount based on the difference between the first theoretical brightness and the first display brightness, and the difference between the second theoretical brightness and the second display brightness, not only the effect of the manufacturing process of the display panel on the displayed image can be eliminated, the influence of display deviation caused by the response speed on the display effect when switching from a still image to dynamic images can also be minimized.

The grayscale compensation amount is compensated for the image displayed afterwards (i.e., the second test image described above), and the grayscale compensation amount may be a positive value or a negative value. When displaying the first test image and the second test image in succession, the difference in brightness when grayscale switching occurs may be determined according to the display brightness B1 of the first test image displayed on the display panel for test and the display brightness B2 of the second test image displayed on the display panel for test.

The grayscale compensation amount is determined based on a difference between the first theoretical brightness b1 and first display brightness B1, a difference between the second theoretical brightness b2 and the second display brightness B2. In the present disclosure, there is no special limitation on how to determine the grayscale compensation amount. For example, the functional relationship of the grayscale compensation amount with the difference between the first theoretical brightness b1 and first display brightness B1 and the difference between the second theoretical brightness b2 and the second display brightness B2 may be determined through a large number of experiments. Specifically, the difference between the first theoretical brightness b1 and first display brightness B1, and the difference between the second theoretical brightness b2 and the second display brightness B2 may be first obtained, and then a software model built in Origin (a software) may be used to determine the functional relationship of the grayscale compensation amount with the difference between the first theoretical brightness and first display brightness and the difference between the second theoretical brightness and the second display brightness.

Before a grayscale switching occurs for each pixel unit in the display panel for display, a grayscale compensation amount for each pixel unit in the image to be displayed may be calculated based on the theoretical grayscale value of the pixel unit in the image to be displayed and a theoretical grayscale value of a pixel unit in the image currently displayed that corresponds to the pixel unit in the image to be displayed. The grayscale compensation amount is superimposed with the theoretical grayscale value of the pixel unit in the image to be displayed to obtain an actual grayscale value of the pixel unit in the image to be displayed. When the display panel is driven to display the image to be displayed according to the actual grayscale value, the actual brightness of each pixel unit in the display panel for display may be close to or even identical to the theoretical brightness of the corresponding pixel unit in the image to be displayed, thereby not only the influence of the manufacturing process of the display panel on the display image can be eliminated, the response speed of the display panel when the grayscale is switched can also be improved, so that the actual display brightness of the image displayed on the display panel is more consistent with the theoretical display brightness of the image, thus reducing or even eliminating the streaking phenomenon when displaying videos, and improving the display effect.

In the present disclosure, the specific number of determining operations included in the grayscale compensation amount determining method is not particularly limited. In the present disclosure, at least one of a first theoretical grayscale of a first test image and a second theoretical grayscale of a second test image in one determining operation is different from that in another determining operation. Each determining operation includes determining a corresponding grayscale compensation amount when switching from an image with a grayscale value to another image with a different grayscale value. After the plurality of determining operations of the grayscale compensation amount determining method, compensations can be made for a plurality of different grayscale switching situations, so that a better display effect can be obtained.

The compensation amount determined through the grayscale compensation amount determining method according to the embodiment of the present disclosure may be applied to actual display situations. In an embodiment, the grayscale compensation amount determining method further includes step S160.

At step S160, a grayscale compensation amount table is generated, wherein the grayscale compensation amount table includes a first theoretical grayscale, a second theoretical grayscale, and a corresponding grayscale compensation amount for each of the determining operations.

FIG. 4 illustrates a schematic diagram of a lookup table for grayscale compensation amount according to an embodiment of the present disclosure. A correspondence relationship among the first theoretical grayscale, the second theoretical grayscale, and the corresponding grayscale compensation amount is stored in the lookup table, wherein the compensation required for 16×16 grayscale switching is shown. The horizontal axis represents the first theoretical grayscale value, and the vertical axis represents the second theoretical grayscale value. Any numerical value in the lookup table indicates the amount of grayscale compensation required when switching from a corresponding first theoretical grayscale to a corresponding second theoretical grayscale. It should be understood that the form of the table for grayscale compensation amount is not limited to the lookup table shown in FIG. 4.

It should be understood by those skilled in the art that although the grayscale compensation amount is shown by x in FIG. 4, the specific compensation amount should be determined using steps S110 to S150 in practical applications.

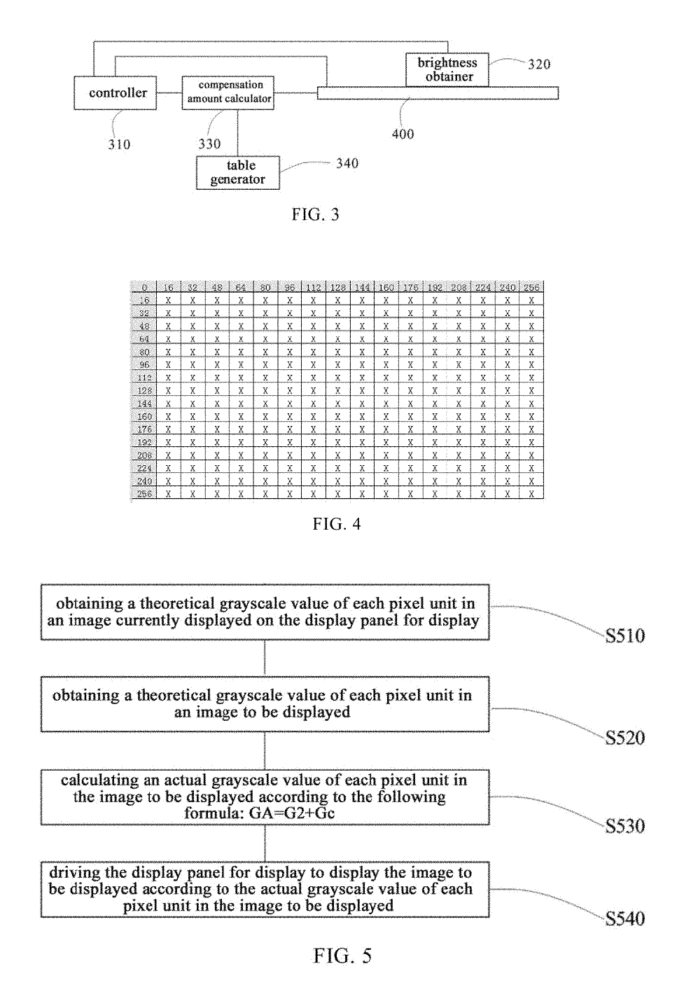

Another aspect of the present disclosure provides a grayscale compensation amount determining device. FIG. 3 illustrates a grayscale compensation amount determining device according to an embodiment of the present disclosure. As shown in FIG. 3, the grayscale compensation amount determining device includes a controller 310, a brightness obtainer 320 and a compensation calculator 330.

The controller 310 is configured to perform steps S110 to S130. Specifically, the controller 310 is configured to control display of a group of test images on a display panel for test 400 in a determining operation, wherein the group of test images include a first test image and a second test image, and wherein the first test image has a first theoretical grayscale g1 that corresponds to a first theoretical brightness b1, and the second test image has a second theoretical grayscale g2 that corresponds to a second theoretical brightness b2.

The brightness obtainer 320 is configured to perform steps S120 to S140, that is, to obtain a first display brightness B1 of the display panel for test 400 when the first test image is being displayed and obtain a second display brightness B2 of the display panel for test 400 when the second test image is being displayed.

The compensation calculator 330 is configured to perform step S150, that is, to determine a grayscale compensation amount based on a difference between the first theoretical brightness b1 and the first display brightness B1, and a difference between the second theoretical brightness b2 and the second display brightness B2.

The grayscale compensation amount determining device according to an embodiment of the present disclosure is configured to perform the grayscale compensation amount determining method according to an embodiment of the present disclosure. The operating principles and beneficial effects of the grayscale compensation amount determining method have been detailed above and are not repeated herein.

In the present disclosure, there is no special requirement for the specific structure of the brightness obtainer 320. For example, as a specific implementation, the brightness obtainer may be a photosensitive sensor.

In order to obtain a better display effect, in one embodiment, the grayscale compensation amount determining method includes a plurality of determining operations. Accordingly, the controller 310 is configured to control display of different groups of images on the display panel for test in different determining operations respectively, wherein at least one of a first theoretical grayscale of a first test image and a second theoretical grayscale of a second test image in one group of test images is different from that in another group of test images.

In one embodiment, the grayscale compensation determining device further includes a table generator 340 configured to perform step S160. That is, the table generator 340 is configured to generate a table for grayscale compensation amount, wherein the table includes a first theoretical grayscale, a second theoretical grayscale, and a corresponding grayscale compensation amount for each of the determining operations.

The controller 310, the compensation amount calculator 330, and the table generator 340 described herein may be physically implemented by analog and/or digital circuits such as an integrated circuit, a microprocessor, a microcontroller, a memory circuit, a passive electronic component, an active electronic component, a hard wiring circuits, and optionally may be driven by firmware and/or software. However, this disclosure is not limited thereto.

In one embodiment, the grayscale compensation amount determining device includes a display panel for test 400. However, it is to be noted that the disclosure is not limited thereto. In another embodiment, the grayscale compensation amount determining device may not include the display panel for test 400. In this embodiment, the test display panel 400 may be purchased by a user, and used in combination with the controller 310, the brightness obtainer 320, and the compensation amount calculator 330 to perform the grayscale compensation amount determining method according to an embodiment of the present disclosure.

In the present disclosure, there is no special limitation on the specific structure of the display panel for test. In one embodiment, the test display is an organic light emitting diode display panel.

Another aspect of the present disclosure provides a driving method for a display panel for display. FIG. 5 illustrates a driving method for a display panel for display according to an embodiment of the present disclosure. As shown in FIG. 5, the driving method includes S510-S540.

At step S510, a theoretical grayscale value of each pixel unit in an image currently displayed on the display panel for display is obtained, wherein the theoretical grayscale value corresponds to the first theoretical grayscale value in the grayscale compensation determining method described above with respect to FIG. 2.

At step S520, a theoretical grayscale value of each pixel unit in an image to be displayed is obtained, wherein the theoretical grayscale value corresponds to the second theoretical grayscale value in the grayscale compensation determining method described above with respect to FIG. 2.

At step S530, an actual grayscale value of each pixel unit in the image to be displayed is calculated according to the following formula:

GA=G2+Gc

wherein GA is an actual grayscale value of the pixel unit to be calculated in the image to be displayed, G2 is a theoretical grayscale value of the pixel unit to be calculated in the image to be displayed, Gc is a grayscale compensation amount for the pixel unit to be calculated in the image to be displayed, and is calculated according to the grayscale compensation determining method described above with respect to FIG. 2 and based on the theoretical grayscale value of the pixel unit to be calculated in the image to be displayed and a theoretical grayscale value of a pixel unit in the image currently displayed that corresponds to the pixel unit to be calculated in the image to be displayed.

At step S540, the display panel for display to display the image to be displayed is driven according to the actual grayscale value of each pixel unit in the image to be displayed.

As described above, in the driving method provided in the present disclosure, the grayscale compensation amount for each pixel unit in the image to be displayed is determined by the above-described grayscale compensation amount determining method.

The image currently displayed by the display panel for display corresponds to the first test image in the grayscale compensation amount determining method, and the image to be displayed corresponds to the second test image in the grayscale compensation amount determining method.

When the display panel is driven to display the image to be displayed according to the actual grayscale value of each pixel unit in the image to be displayed, the actual brightness of each pixel unit in the display panel for display may be close to or even identical to the theoretical brightness of the corresponding pixel unit in the image to be displayed, thereby not only the influence of the manufacturing process of the display panel on the display image can be eliminated, the response speed of the display panel for display when switching from an image currently displayed to an image to be displayed can also be improved, thus reducing or even eliminating the streaking phenomenon when displaying videos, and improving the display effect.

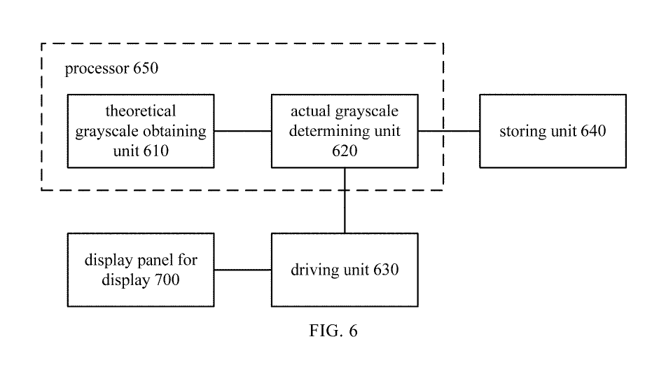

Another aspect of the present disclosure provides a driving circuit for a display panel for display. FIG. 6 illustrates a driving circuit for a display panel for display 700 according to an embodiment of the present disclosure. As shown in FIG. 6, the driving circuit includes a processor 650 which includes a theoretical grayscale obtaining unit 610 and an actual grayscale determining unit 620. The driving circuit further includes a driving unit 630.

The theoretical grayscale obtaining unit 610 is configured to perform step S510 and step S520. That is, the theoretical grayscale obtaining unit 610 is configured to obtain a theoretical grayscale value of each pixel unit in an image currently displayed by the display panel for display which corresponds to the first theoretical grayscale value in the device described above with respect to FIG. 3, and obtain a theoretical grayscale value of each pixel unit in an image to be displayed which corresponds to the second theoretical grayscale value in the device described above with respect to FIG. 3.

The actual grayscale determining unit 620 is configured to perform step S530. That is, the actual grayscale determining unit is configured to calculate an actual grayscale value of each pixel unit in the image to be displayed according to the following formula:

GA=G2+Gc

wherein GA is an actual grayscale value of the pixel unit to be calculated in the image to be displayed, G2 is a theoretical grayscale value of the pixel unit to be calculated in the image to be displayed, Gc is a grayscale compensation amount for the pixel unit to be calculated in the image to be displayed, and is calculated by the device described above with respect to FIG. 3 based on the theoretical grayscale value of the pixel unit to be calculated in the image to be displayed and a theoretical grayscale value of a pixel unit in the image currently displayed that corresponds to the pixel unit to be calculated in the image to be displayed

The driving unit 630 is configured to perform step S540. That is, the driving unit 630 is configured to drive the display panel for display to display the image to be displayed according to the actual grayscale value of each pixel unit in the image to be displayed.

The driving circuit is configured to perform the driving method according to an embodiment of the present disclosure. The operating principles and beneficial effects of the driving method have been detailed above and are not repeated herein.

It is to be noted that the driving circuit can not only drive the display panel for display to display video, but also drive the display panel for display to display a still picture.

In an embodiment, the driving circuit includes a storing unit 640 configured to store a table for grayscale compensation amount. In this embodiment, after the theoretical grayscale value of each pixel unit in the currently displayed image and the theoretical grayscale value of each pixel unit in the image to be displayed have been obtained, the actual grayscale determining unit performs a lookup operation in the table for grayscale compensation amount to obtain a grayscale compensation amount for each pixel unit in the image to be displayed.

Another aspect of the present disclosure provides a display device including a display panel for display and a driving circuit, wherein the driving circuit is the driving circuit described above according to the embodiments of the present disclosure, and the display panel for display has a same structure as the display panel for test.

In the present disclosure, the structure of the display panel for display is the same as that of the display panel for test in the grayscale compensation amount determining method, so that a more accurate grayscale compensation amount can be obtained. When the display panel for display is an organic light emitting diode display panel, the display panel for test that is used to determine the grayscale compensation amount is also an organic light emitting diode display panel produced in the same batch

As described above, by utilizing the grayscale compensation amount determining method, the grayscale compensation amount determining device configured to perform the grayscale compensation amount determining method, the driving method for the display panel for display, and the driving circuit configured to perform the driving method, in a case where different images are displayed on the display device including the driving circuit, not only the influence of the manufacturing process of the display panel on the images being displayed may be eliminated, uneven brightness and other problems caused by insufficient response speed during grayscale switching can also be reduced or even eliminated, thus a better display effect may be obtained.

It could be understood that the above implementations are merely exemplary embodiments adopted for describing the principle of the present disclosure, and the present disclosure is not limited thereto. Various variations and improvements may be made by those of ordinary skill in the art without departing from the spirit and essence of the present disclosure, and these variations and improvements shall also fall into the protection scope of the present disclosure.

What is claimed is:

1. A grayscale compensation amount determining method including a plurality of determining operations, each of the determining operations comprising:
controlling display of a first test image on a display panel for test, wherein the first test image has a first theoretical grayscale that corresponds to a first theoretical brightness;
obtaining a first display brightness of the display panel for test when the first test image is being displayed;
controlling display of a second test image on the display panel for test, wherein the second test image has a second theoretical grayscale that corresponds to a second theoretical brightness;
obtaining a second display brightness of the display panel for test when the second test image is being displayed; and
determining a grayscale compensation amount based on a difference between the first theoretical brightness and the first display brightness, and a difference between the second theoretical brightness and the second display brightness.

2. The grayscale compensation amount determining method of claim 1, further comprising:
generating a table for grayscale compensation amount, wherein the table includes a first theoretical grayscale, a second theoretical grayscale, and a corresponding grayscale compensation amount for each of the determining operations.

3. The grayscale compensation amount determining method of claim 1, further comprising: ensuring that at least one of a first theoretical grayscale of a first test image and a second theoretical grayscale of a second test image in one determining operation is different from that in another determining operation.

4. The grayscale compensation amount determining method of claim 1, further comprising ensuring that:
the first test image and the second test image are both images with solid color,
the first theoretical grayscale value of the first test image is different from the second theoretical grayscale of the second test image, and
the color of the first test image is the same as that of the second test image.

5. A grayscale compensation amount determining device, comprising:
a controller configured to control display of a group of test images on a display panel for test in a determining operation, wherein the group of test images include a first test image and a second test image, and wherein the first test image has a first theoretical grayscale that corresponds to a first theoretical brightness, and the second test image has a second theoretical grayscale that corresponds to a second theoretical brightness;
a brightness obtainer configured to obtain a first display brightness of the display panel for test when the first test image is being displayed and obtain a second display brightness of the display panel for test when the second test image is being displayed; and
a compensation calculator configured to determine a grayscale compensation amount based on a difference between the first theoretical brightness and the first display brightness, and a difference between the second theoretical brightness and the second display brightness.

6. The grayscale compensation amount determining device of claim 5, wherein the controller is configured to control display of different groups of images on the display panel for test in different determining operations respectively, and wherein at least one of a first theoretical grayscale of a first test image and a second theoretical grayscale of a second test image in one group of test images is different from that in another group of test images.

7. The grayscale compensation amount determining device of claim 5, further comprising the display panel for test.

8. The grayscale compensation amount determining device of claim 7, wherein the display panel for test is an organic light emitting diode display panel.

9. The grayscale compensation amount determining device of claim 5, wherein the brightness obtainer is a photosensitive sensor.

10. The grayscale compensation amount determining device of claim 5, further comprising a table generator configured to generate a table for grayscale compensation amount, wherein the table includes a first theoretical grayscale, a second theoretical grayscale, and a corresponding grayscale compensation amount for each of the determining operations.

11. A driving method for a display panel for display, comprising:
obtaining a theoretical grayscale value of each pixel unit in an image currently displayed on the display panel for display which corresponds to the first theoretical grayscale value in the grayscale compensation amount determining method of claim 1;
obtaining a theoretical grayscale value of each pixel unit in an image to be displayed which corresponds to the second theoretical grayscale value in the grayscale compensation amount determining method of claim 1;
calculating an actual grayscale value of each pixel unit in the image to be displayed according to the following formula:
GA=G2+Gc
wherein GA is an actual grayscale value of the pixel unit to be calculated in the image to be displayed,
G2 is a theoretical grayscale value of the pixel unit to be calculated in the image to be displayed,
Gc is a grayscale compensation amount for the pixel unit to be calculated in the image to be displayed, and is calculated by the grayscale compensation amount determining method of claim 1 based on the theoretical grayscale value of the pixel unit to be calculated in the image to be displayed and a theoretical grayscale value of a pixel unit in the image currently displayed that corresponds to the pixel unit to be calculated in the image to be displayed; and
driving the display panel for display to display the image to be displayed according to the actual grayscale value of each pixel unit in the image to be displayed.

12. A driving circuit for a display panel for display, comprising:
a processor comprising a theoretical grayscale obtaining unit and an actual grayscale determining unit, wherein:
the theoretical grayscale obtaining unit is configured to:
obtain a theoretical grayscale value of each pixel unit in an image currently displayed by the display panel for display which corresponds to the first theoretical grayscale value in the grayscale compensation amount determining device of claim 5, and
obtain a theoretical grayscale value of each pixel unit in an image to be displayed which corresponds to the second theoretical grayscale value in the grayscale compensation amount determining device of claim 5,
the actual grayscale determining unit is configured to calculate an actual grayscale value of each pixel unit in the image to be displayed according to the following formula:
GA=G2+Gc
wherein GA is an actual grayscale value of the pixel unit to be calculated in the image to be displayed,
G2 is a theoretical grayscale value of the pixel unit to be calculated in the image to be displayed,
Gc is a grayscale compensation amount for the pixel unit to be calculated in the image to be displayed, and is calculated by the grayscale compensation amount determining device of claim 5 based on the theoretical grayscale value of the pixel unit to be calculated in the image to be displayed and a theoretical grayscale value of a pixel unit in the image currently displayed that corresponds to the pixel unit to be calculated in the image to be displayed; and
a driving unit for driving the display panel for display to display the image to be displayed according to the actual grayscale value of each pixel unit in the image to be displayed.

13. The driving circuit of claim 12, further comprising a storing unit configured to store a table for grayscale compensation amount that includes the grayscale compensation amount.

14. A display device comprising a display panel for display and a driving circuit, wherein the driving circuit is the driving circuit of claim 12, and the display panel for display is an organic light emitting diode display panel.
